(19) United States
(12) Patent Application Publication
(10) Pub. No.: US 2005/0087581 A1
(43) Pub. Date: Apr. 28, 2005

(54) Welding Alignment Device, and Methods of Using Same

(76) Inventors: Gregory K. Otten, Houston, TX (US); Curtis Jess Parker, Orange, TX (US)

Correspondence Address: JEFFREY E. DALY;GRANT PRIDECO, L.P., 400 N. SAM HOUSTON PARKWAY EAST, SUITE 900, HOUSTON, TX, 77060, US

(21) Appl. No.: 10/904,013

(22) Filed: Oct. 19, 2004

Related U.S. Application Data
(60) Provisional application No. 60/481,566, filed on Oct. 27, 2003.

(51) Int. Cl. B23K 37/04

(52) U.S. Cl. 228/49.1

(57) ABSTRACT

The present invention is generally directed to a welding alignment device for positioning a first component and a second component together such that the components may be welded together. In one illustrative embodiment, the device comprises a moveable body, a cradle assembly coupled to the body, the cradle assembly adapted to have at least the first component positioned therein, and a motor that, when actuated, causes an alignment force to be applied to the first component that urges the first component into contact with the second component. In another illustrative embodiment, the welding alignment device comprises a moveable body, means for supporting at least the first component when the first component is positioned therein, the means for supporting the first component being coupled to the body, and means for generating an alignment force to be applied to the first component that urges the first component into contact with the second component, at least a portion of the means being coupled to the moveable body.

### CROSS REFERENCE TO RELATED APPLICATIONS

The present invention claims priority from pending U.S. Provisional Patent Application Ser. No. 60/481,566 filed on Oct. 27, 2003.

### BACKGROUND OF THE INVENTION

1. Field of the Invention

The present invention is generally directed to the field of welding, and, more particularly, to a welding alignment device, and various methods of using same.

2. Description of the Related Art

In the oilfield industry, many separate lengths of pipe are coupled together to create, in some cases, very long conduit structures. Such structures may be used for a variety of purposes, e.g., transportation of oil and gas, lining of wells, etc. Typically, each section of pipe is provided with a threaded pin connector (male connector) on one end and a threaded box connector (female connector) on the other end. Pipe sections are coupled to one another by threadingly engaging the pin connector on one tubular with a box connector on another tubular. This process is continued until the desired length of the structure is completed.

In some cases, a section of pipe is provided and the pin and box connectors are welded onto the opposite ends of the pipe. The diameter of the pipe may vary depending on the particular application, e.g., 20″, 26″, 30″, etc. The wall thickness of the pipe may also vary depending upon the particular application, i.e., the wall thickness may vary between approximately 0.438-2.5 inches.

As indicated in FIG. 1, in some cases, the joint 210 between the pipe 212 and the connector 214 is a single bevel joint in which the standard pipe joint bevel of approximately 30 degrees is provided on both components, as indicated in FIG. 1. The longitudinal centerline 213 of the pipe 212 is schematically depicted in FIG. 1 as are exterior surfaces 218 and interior surfaces 220 of the pipe 212 and connector 214. Also depicted in FIG. 1 is a vertical land 215 formed on both the pipe 21 2 and the connector 214. Typically, the joint 210 is filled by performing one or more welding passes from the outside of the joint 210.

Joining the pipe 21 2 and connector 214 using the joint 210 configuration depicted in FIG. 1 presents several problems. For example, especially with large diameter piping, obtaining axial alignment between the pipe 212 and the connector 214 is a very difficult and time-consuming process due to a variety of reasons, e.g., the pipe and/or connector being out-of-round, the weight and stiffness of the pipe 212 and connector 214, waviness in the pipe 212, etc. Typically, prior art techniques for axially aligning the pipe 212 and connector 214 might involve welding on various clips and manipulating the pipe 212 and/or connector 214 until such time as the proper axial alignment is achieved. Such manipulation of the components is very difficult due to, among other things, the physical size and weight of the pipe 212 and the connector 214. Thereafter, prior art welding processes often involved tack welding the joint 210 at several locations around the perimeter of the joint 210, followed by performing a MIG welding process to lay down a relatively small weld bead in the joint 210 at the root 219. Thereafter, the joint 210 was completed by performing any of a variety of known welding processes to completely fill the joint 210. Due to the volume of the joint 210, it typically took several passes, i.e., multiple weld beads, to completely fill the joint 210.

The present invention is directed to a device and various methods that may solve, or at least reduce, some or all of the aforementioned problems.

### BRIEF SUMMARY OF THE INVENTION

The present invention is generally directed to a welding alignment device for positioning a first component and a second component together such that the components may be welded together. In one illustrative embodiment, the device comprises a moveable body, a cradle assembly coupled to the body, the cradle assembly adapted to have at least the first component positioned therein, and a motor that, when actuated, causes an alignment force to be applied to the first component that urges the first component into contact with the second component.

In another illustrative embodiment, the welding alignment device for positioning a first component and a second component together such that the components may be welded together comprises a moveable body, a cradle assembly coupled to the body, the cradle assembly comprising a plurality of rollers that are adapted to engage an exterior surface of at least the first component when the first component is positioned in the cradle assembly, an electric motor, a gear reduction drive that is operatively coupled to the electric motor, a pinion that is operatively coupled to the gear reduction drive, and a rack that is fixedly coupled to a base frame, the rack being operatively engaged with the pinion, whereby the motor, when actuated, causes an alignment force to be applied to the first component that urges the first component into contact with the second component.

In yet another illustrative embodiment, the welding alignment device for positioning a first component and a second component together such that the components may be welded together comprises a moveable body, means for supporting at least the first component when the first component is positioned therein, the means for supporting the first component being coupled to the body, and means for generating an alignment force to be applied to the first component that urges the first component into contact with the second component, at least a portion of the means being coupled to the moveable body.

### BRIEF DESCRIPTION OF THE DRAWINGS

The invention may be understood by reference to the following description taken in conjunction with the accompanying drawings, in which like reference numerals identify like elements, and in which:

FIG. 1 is a cross-sectional depiction of an illustrative prior art weld joint between a pipe and a connector.

FIG. 2 is a right side view of a welding alignment device in accordance with one illustrative embodiment of the present invention.

FIG. 3 is a left side view of the device depicted in FIG. 2.

FIG. 4 is an end view of the device depicted in FIG. 2.

FIG. 5 is an enlarged, close-up view depicting one illustrative embodiment of a rack and pinion system that may be employed with the present invention.

FIG. 6 is an enlarged, close-up view of an illustrative means of supporting a welded component in accordance with one embodiment of the present invention.

FIG. 7 is a close-up view of an illustrative welding system that may be employed with the present invention.

FIGS. 8A-8D are cross-sectional views depicting various details of a weld joint between a pipe and a connector in which an angular alignment land is provided wherein the connector and the pipe may be urged together and aligned in accordance with one illustrative embodiment of the present invention.

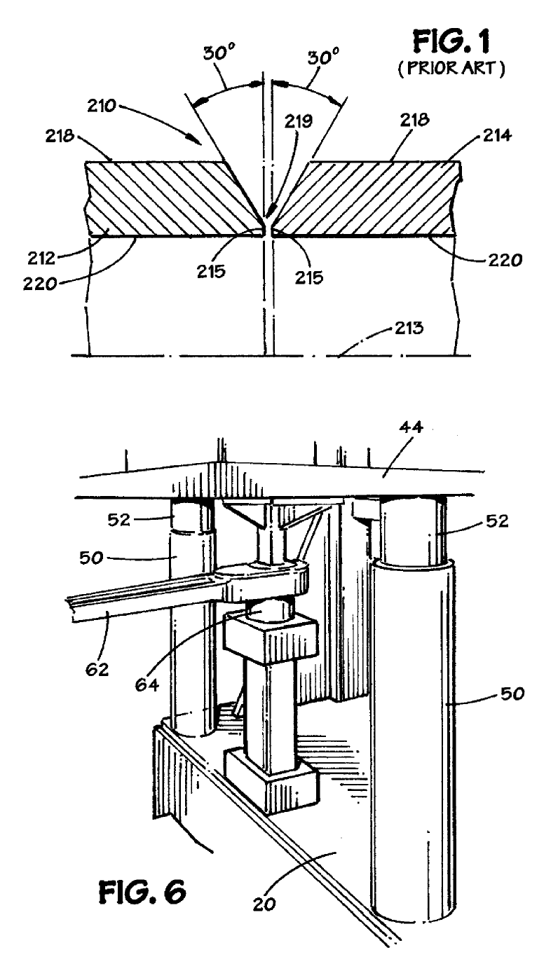

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION AND THE PREFERRED EMBODIMENT

Illustrative embodiments of the invention are described below. In the interest of clarity, not all features of an actual implementation are described in this specification. It will, of course, be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The present invention will now be described with reference to the attached drawings which are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

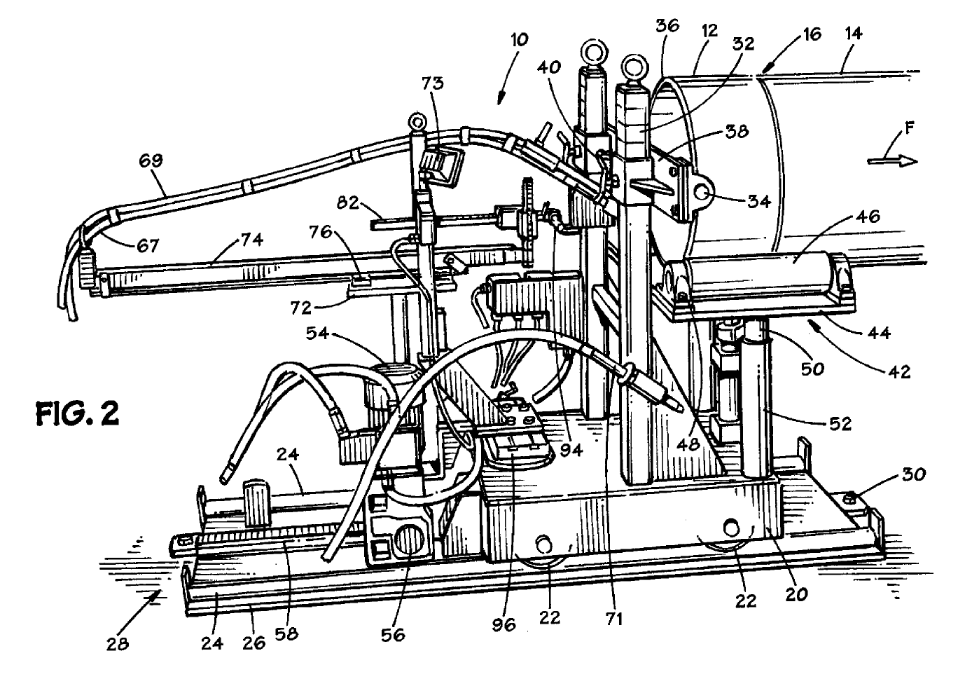

The present invention is generally directed to a device that is adapted for aligning and welding two components to one another. As depicted in FIG. 2, the alignment device 10 is adapted to assist in the alignment of a first component 12 and second component 14 such that the two components may be welded together. In the embodiments described and disclosed herein, the components 12, 14 are tubular components. For example, in the depicted embodiment, the first component 12 is simply a pipe stub and the second component 14 is a section of pipe (API 5L pipe). However, as will be recognized by those skilled in the art after a complete reading of the present application, the present invention is not limited in its use to any particular type of components that may be welded together. For example, the first component 12 may be a flanged connector or a threaded connector, e.g., a female connector (with internal threads) or a male connector (with external threads). Thus, the present invention should not be considered as limited to the particular components 12, 14 disclosed herein unless such limitations are expressly recited in the appended claims.

As will be described more fully below, the welding alignment device 10 is comprised of means for axially urging the first and second components 12, 14 together (in the direction indicated by the arrow “F”) to define a weld joint 16 where the components 12, 14 will be subsequently welded together. The device 10 is also comprised of means for controlling various operational aspects of the device as disclosed more fully below.

In the disclosed embodiment, the welding alignment device 10 is comprised of a moveable body 20 that is mounted on a plurality of rollers 22. The rollers 22 have a ‘V’ shaped groove and they are adapted for rolling engagement with a plurality of rails 24 that are secured to a base frame 26. The base frame 26 is secured to the cement floor 28 by a plurality of threaded connections 30, e.g., bolts and nuts. The welding alignment device 10 is provided with various structural members that are used to support various components of the device 10. For example, the welding alignment device 10 is comprised of a plurality of upstanding posts 32, each of which is adapted to support an end roller 34. The end rollers 34 are adapted to engage an end surface 36 of the first component 12 during the alignment process, as described more fully below. The end rollers 34 are releasably coupled (with a plurality of threaded connections) to a mounting bracket 38 that is releasably coupled to the post 32 by a set screw 40. The position of the end rollers 34 may be vertically adjusted by loosening the set screw 40 that secures the mounting bracket 38 to the post 32. When the end roller 34 is properly located, it may be secured in place by tightening the set screw 40.

The welding alignment device 10 further comprises a cradle assembly 42 for supporting at least one of the components 12, 14 to be welded. The cradle assembly is coupled to the moveable body 20. The cradle assembly 42 is generally comprised of a mounting plate 44, a plurality of support rollers 46 that are releasably coupled to the mounting plate 44 with a plurality of threaded connections 48, e.g., nuts and bolts, and a plurality of downwardly extending guide posts 50. The guide posts 50 are adapted to be positioned within guide structures 52 that are secured to the moveable body 20 of the welding alignment device 10. The guide posts 50 and guide structures 52 may have any desired configuration, e.g., circular, squared tubing, etc. FIG. 6 is an enlarged view of the underside of the cradle assembly 42. The vertical position of the cradle assembly 42 (and the support rollers 46 coupled thereto) is controlled by a ratchet wrench 62 that is attached to a threaded rod 64. By use of the ratchet wrench 62, the support rollers 46 may be properly positioned (in the vertical direction) such that they provide adequate support to one or both of the components 12, 14 during the alignment and/or welding process, i.e., the rollers 46 are positioned such that they engage the exterior surface of the first and/or second component.

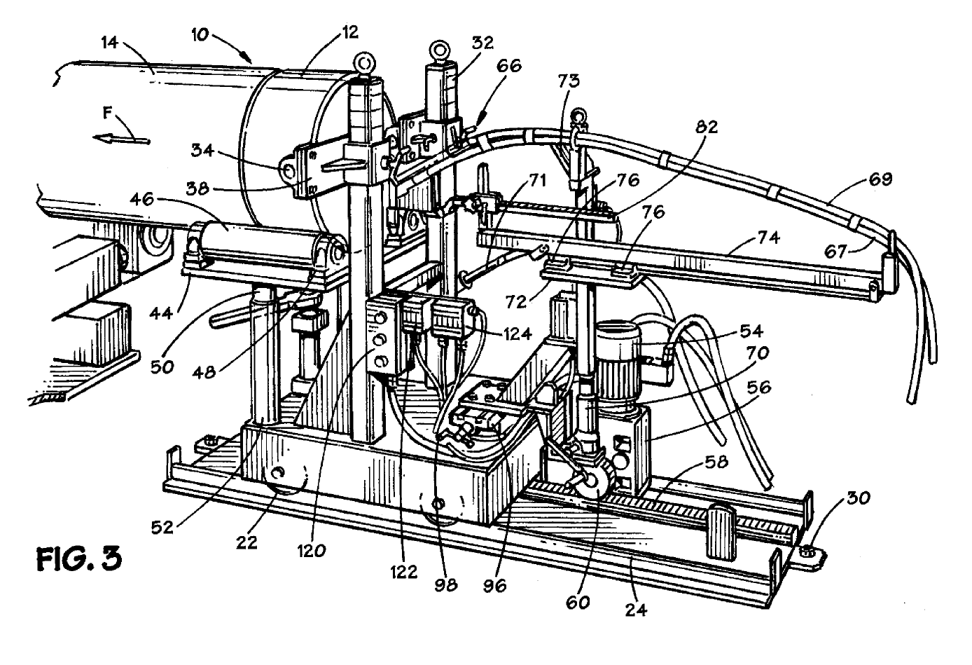

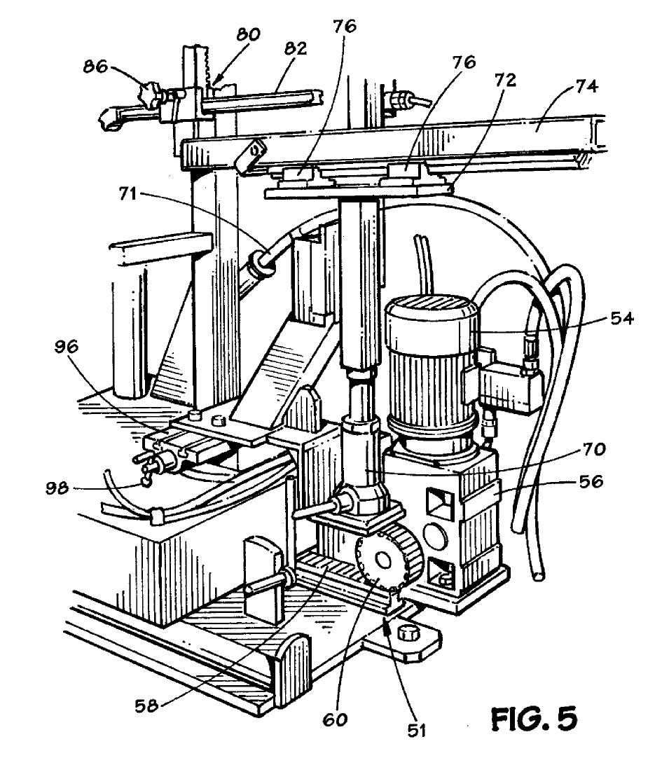

The welding alignment device 10 is adapted to exert an axial alignment force F on at least one of the two components 12, 14 before and/or during the welding process that is performed to join the components 12, 14 together. In the disclosed embodiment, this is accomplished through use of a rack and pinion system 51 (see FIGS. 3 and 5) that is driven by an electric motor 54 using a reduction gear box 56. In the depicted embodiment, the motor 54 is a one horsepower AC motor that is fixedly coupled to the moveable body 20. The gear box 56 has an internal worm gear drive that provides a 3:1 reduction. In lieu of an electrical motor, a pneumatic or hydraulic motor may also be employed. The system 51 is comprised of a rack 58 and a pinion 60. The rack and pinion system 51 may be any of a variety of commercially available systems. In the depicted embodiment, the rack 58 is approximately one inch in width, and it has approximately two threads per inch. The size of the various components described above may vary depending on the particular application and the desired amount of axial alignment force F to be applied to the components 12, 14. Moreover, the present invention should not be considered as limited to the specifically disclosed rack and pinion system 51 as other types of systems may be employed. That is, any type of power transmission system may be employed, e.g., hydraulic, pneumatic, or electrical power transmission systems.

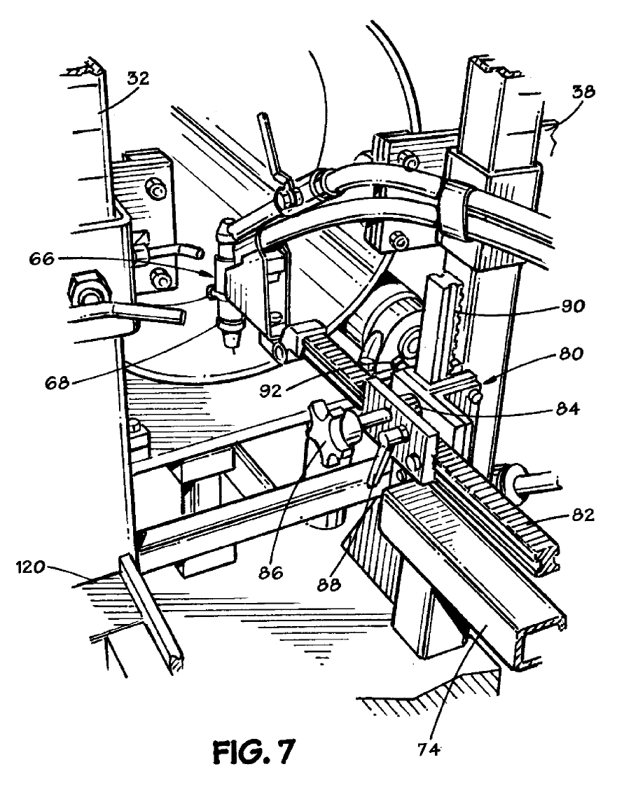

The present invention also enables positioning of a welding device 66 (see FIG. 7), e.g., a welding torch 68, such that it may be used to weld at least a portion of the weld joint 16 between the two components 12, 14. That is, in one embodiment, the welding torch 68 is operatively coupled to the moveable body 20 in such a manner that it may be positioned at any desired location. In the attached drawings, the device 10 is depicted in the position wherein the welding torch 68 may be used to weld the interior portion of the weld joint 16. However, the device 10 is adjustable such that the outer portion of the weld joint 16 can be welded with the device 10. Thus, the present invention should not be considered as limited to any particular type or configuration of welding device 66 unless such limitations are clearly set forth in the appended claims. Moreover, the present invention may be employed in situations where a welding device 66 is not operatively coupled to or controlled by the device 10. For example, the device 10 may be used simply to aid in the alignment of the components 12, 14. Thereafter, a separate welding machine or individual may be used to complete the weld joint 16. As another alternative, a camera assist welding system may be employed. In such a system, a camera (not shown) may be employed to allow visual observation of the weld joint. The location of the welding torch may be adjusted manually or by power or automated transmission systems.

In the depicted embodiment, the welding device 66 comprises a welding torch 68 that is part of a submerged arc welding (SAW) system. However, it should be understood that the device 10 may be employed with any type of welding system or technique, e.g., GMAW, etc. In the depicted embodiment, the device 10 is capable of adjusting the positioning of the welding torch 68 in three different directions. There are several positioning mechanisms that may be employed with the illustrative embodiment of the device 10 depicted in the attached drawings. Some of these mechanisms may be considered as relatively coarse positioning mechanisms while others provide relatively fine positioning control.

The relatively coarse vertical adjustment of the welding torch 68 is provided by a hand-driven, fine-threaded jack 70 (see FIGS. 3 and 5). If desired, coarse axial positioning of the welding torch 68 may be achieved by axial movement of the body 20. The jack 70 is operatively coupled to a mounting plate 72. A support member 74 is releasably coupled to the mounting plate 72 by a plurality of mounting blocks 76. The member 74 may be locked in place once it is in the desired position by a variety of techniques. Fine horizontal positioning control of the welding torch 68 is provided via a small milling table 96 (see FIGS. 3 and 5) that may be controlled by manipulating a plurality of handles 98.

An axial rack and pinion system comprised of an axial rack 82, a pinion 84, a handle 86 and a lock lever 88 enables accurate axial positioning of the welding torch 68. A vertical axial positioning system comprised of a vertical rack 90, a pinion (not shown), a handle 94 (see FIG. 2) and a lock lever 92 enables accurate vertical positioning of the welding torch 68.

The welding and alignment device 10 contains a wire feed unit (not shown) coupled with an air pressure flux delivery system (not shown). Welding wire is provided to the welding torch 68 via the line 67, and welding flux is provided to the weld joint via line 69. A vacuum hose 71 can be used by the operator to recover unused flux.

The device 10 is comprised of a plurality of controls to control various aspects of the device. The various controls are best seen in FIG. 3. For example, a motor control panel 120 is provided to control the operation of the electric motor 54. The motor control panel 120 allows for variable speed control and an in/out switch to control axial movement of the movable body 20 of the device 10. The center control panel 122 provides on and off control for the welding system 66. The right-most control panel 124 is used to turn off/on an auxiliary worklamp 73 (see FIG. 2) and vacuum.

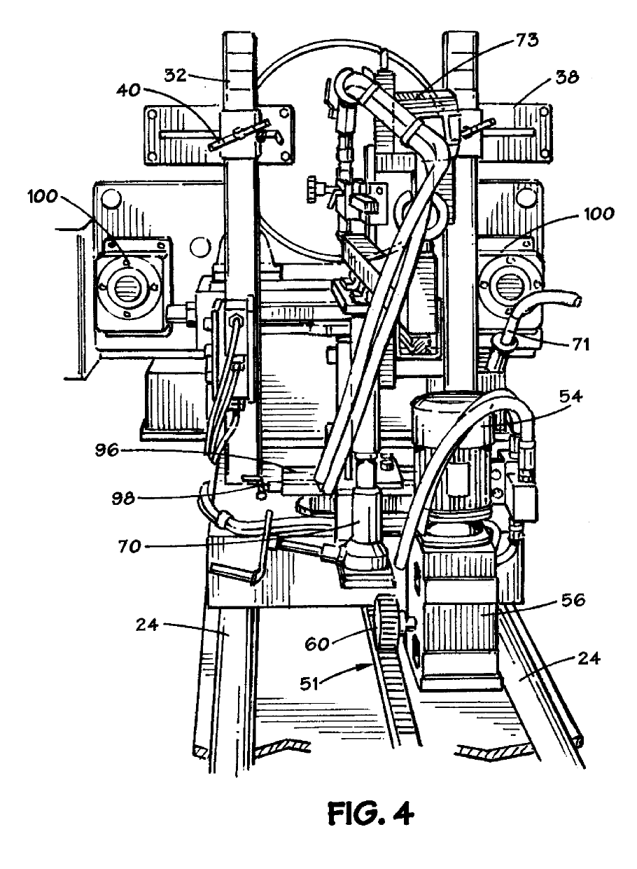

Illustrative examples of how the present invention may be employed will now be described with reference to the attached drawings. As set forth above, the device 10 may be employed to urge the components 12, 14 together and weld the joint 16 therebetween. In one particular embodiment, the present invention may be used in welding tubular connectors (threaded or flanged) onto relatively long sections of tubular pipe. For example, such long tubular pipe sections may be supported by multiple sets of known pipe rollers 100, as best seen in FIG. 4.

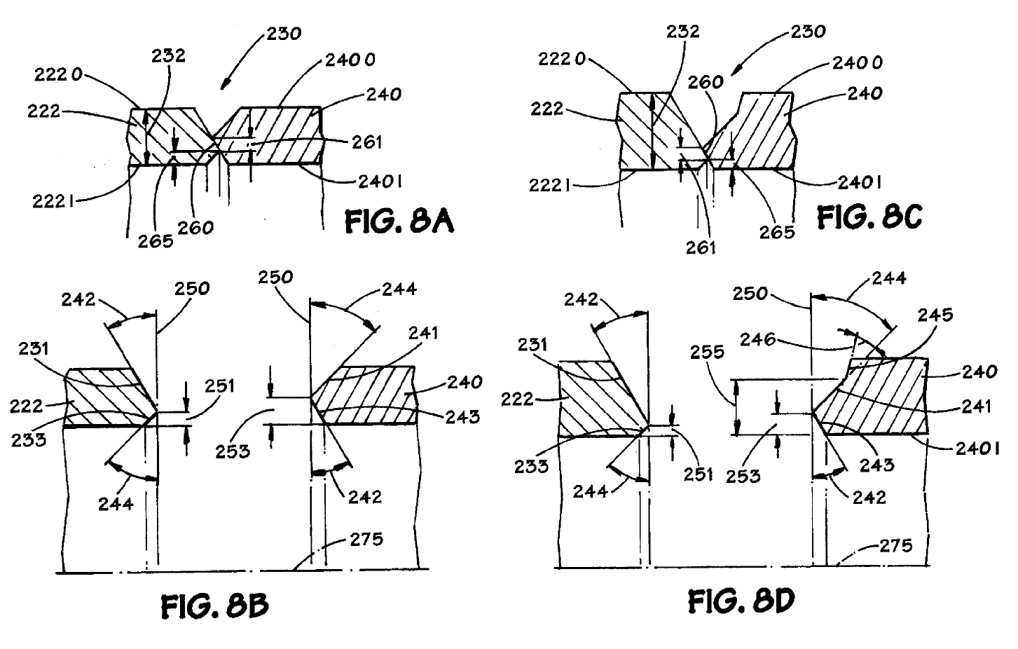

In one very specific embodiment, the present invention may be employed when the component 12 is a generic connector and the component 14 is a section of API 5L pipe. In this embodiment, the connector 240 and the pipe 222 may be provided with various beveled surfaces to thereby define an angular alignment land 260, as best shown in FIGS. 8A-8B. As shown therein, an illustrative pipe 222 is adapted to be welded to a generic connector 240, which may be threaded or not. In FIGS. 8A-8B, a longitudinal axis or centerline 275 of the pipe 222 is depicted. In the lower portions of FIGS. 8A-8B, the pipe 222 and the connector 240 are depicted in an axially spaced-apart relationship, whereas in the upper portions of FIGS. 8A-8B, the pipe 222 and the connector 240 are depicted in an illustrative abutting position. As set forth above, the pipe 222 should be understood to be any type of pipe and the connector 240 should be understood to be any type of connector. In general, the details of the weld joint 230, i.e., geometry and dimensions, may vary depending upon the wall thickness 232 of the pipe 222. The pipe 222 has an inner surface 2221 and an outer surface 222O. Similarly, the connector 240 has an inner surface 2401 and an outer surface 240O. In the illustrative embodiment, the pipe 222 has an outer beveled surface 231 and an inner beveled surface 233. The connector 240 has an outer beveled surface 241 and an inner beveled surface 243. In joints 230 wherein the wall thickness 232 is greater than 1.375 inches, the connector 240 may have a secondary outer beveled surface 245 (see FIG. 8D). However, it should be understood that the present invention is not limited to use with components 12, 14 having such beveled surfaces. Moreover, even when components 12, 14 have such beveled surfaces, the present invention should not be considered as limited to the particular beveled configurations depicted herein.

The pipe outer beveled surface 231 and connector inner beveled surface 243 are beveled at an angle 242 of approximately 30 degrees±5 degrees with respect to a line 250 normal to the longitudinal centerline 275 of the pipe 222. In a particular embodiment, the angle may be 30 degrees±1 degree. The pipe inner beveled surface 233 and connector outer beveled surface 241 are beveled at an angle 244 of approximately 45 degrees±5 degrees with respect to the line 250. In the depicted embodiment, the surfaces 231 and 243 have the same bevel angle and the surfaces 233 and 241 have the same bevel angle although that is not required in all embodiments of the present invention. For the embodiments where the wall thickness 232 is greater than 1.375 inches, the secondary outer beveled surface 245 is beveled at an angle 246 of approximately 15 degrees±5 degrees with respect to a normal line 250. The secondary outer beveled surface 245 is provided to, among other things, reduce the volume of the weld joint 230. As such, the secondary outer beveled surface 245 may not be required in all embodiments of the present invention.

The pipe inner beveled surface 233 has a radial dimension 251 approximately 0.25 inches, and the connector inner beveled surface 243 has a radial dimension 253 of approximately 0.50 inches. If employed, the secondary outer beveled surface 245 may begin at a radial dimension 255 of approximately 1.25 inches from the inner surface 2401 of the connector 240. Of course, these dimensions may vary depending upon the particular application.

As depicted in FIGS. 8A-8D, in one illustrative embodiment, the weld joint 230 of the present invention has an angular alignment land 260 with an illustrative radial thickness 261 of approximately 0.25 inches. The radial thickness 261 of the angular alignment surface 260 may vary from approximately 0.25-0.375 inches depending upon the particular application. That is, the angular alignment land 260 is positioned at an angle, relative to the line 250, that may vary from, for example, approximately 25 to 50 degrees on either side of the line 250. In general, as the angle 242 gets larger (relative to the line 250) the self-alignment capabilities of the joint 230 tend to increase, but at some point the ability to achieve complete weld penetration of the joint 230 becomes more difficult also. Thus, these competing concerns must be address for each particular application.

In one illustrative embodiment, for pipes 222 having a wall thickness 232 of 0.75 inches or greater, the joint 230 is configured such that the angular alignment land 260 begins at a radial location 265 that is approximately 0.25 inches from the inner surface 222I of the pipe 222. However, depending on the particular application, the radial location 265 may vary. For example, for pipes 222 having a wall thickness 232 of approximately 0.50 inches, the radial location 265 may be approximately 0.125 inches from the inner surface 222I of the pipe 222.

For pipes 222 having a wall thickness 232 less than one inch, the angular alignment land 260 is also provided, and it may also have a radial thickness 261 of approximately 0.25 inches. For such relatively thin-walled pipe 222, the angular alignment surface 260 may be positioned at approximately mid-thickness of the pipe 222. For example, for a pipe thickness 232 of 0.500 inches, the radial dimension 251 (see FIG. 8A) of the pipe inner beveled surface 233 may be 0.125 inches, thereby leaving an additional 0.125 inches of thickness beyond the height 261 of the angular alignment land 260. (0.125″ internal bevel height+0.25 inches angular alignment land thickness+0.125″ outer bevel height=0.50″ total pipe wall thickness). The precise values would, of course, vary depending upon the particular application. However, it is envisioned that in at least some embodiments the angular alignment land 260 would usually have a radial thickness 261 ranging from approximately 0.25-0.375 inches. It should also be understood that in relatively thin-walled pipes 222, the position of the angular alignment land 260 within the wall of the pipe may vary, i.e., it need not be positioned at the mid-thickness of the pipe 222 in all situations.

The angular alignment land 260 provides many benefits with respect to the alignment of the pipe 222 and the connector 240. For example, in the depicted embodiment, due to the interaction of the pipe outer beveled surface 231 and the connector inner beveled surface 243 of the connector 240, the pipe 222 and connector 240 tend to self-align themselves (in an axial direction) when they are axially urged together with sufficient force. Such force may be applied by a variety of techniques.

Initially, a long section of pipe, e.g., component 14, may be placed in the pipe rollers 100. Then, a component 12 to be welded to the pipe, such as a threaded connector, may be positioned in the cradle assembly 42 and supported thereby by the support rollers 46. The various controls of the welding alignment device 10 are then actuated or manipulated so as to position the pipe 14 and the connector 12 in approximately aligned positions. For example, the ratchet wrench 62 may be manipulated to approximately align the centerline of the connector 12 with the centerline of the pipe 14 on the rollers 10. The connector 12 may then be urged toward the pipe 14 (in the direction indicated by the arrow F in FIG. 2) by actuating the motor 54 to thereby drive the movable body 20 in an axial direction via the rack 58 and pinion 60 to generate the axial force F. In one illustrative embodiment, the motor 54 applies a constant axial alignment force to the components 12, 14 throughout the welding process. In other embodiments, the axial alignment force may be applied until sufficient weld metal has been deposited such that the axial alignment of the two components 12, 14 is no longer an issue. The motor 54 is wired such that the windings do not burn out as the force is applied during the alignment process. For example, efforts may be made to reduce the amperage experienced by the motor 54 to avoid failure. As a specific example, a motor with an excessive amperage rating (relative to operating requirements) may be employed and/or an amperage limiting device may be employed to insure that the motor 54 is not exposed to destructive amperage levels during operations.

In one illustrative embodiment, the device 10 maybe used to provide a relatively large axial force F that acts to urge the components 12, 14, e.g., a connector and a pipe, together. In the illustrative example where the connector 240 is to be welded to the pipe 222 at a weld joint 230 having an angular alignment land 260, the axial force applied by the device 10 may be only slightly less than the weight of the pipe 222. In some cases, the rollers 100 may be canted forward (toward the device 10) such that the pipe 222 is urged toward the device 10 as the pipe rotates. In other embodiments, a fixture (not shown) may be provided at the opposite end of the pipe 222, wherein the fixture is comprised of a plurality of end rollers (similar to end rollers 34) that are adapted to engage an opposite end of the pipe 222.

Through use of the present invention, alignment of relatively large tubular components, e.g., components having a diameter of 20, 26 and 28 inches and larger, may be accomplished more quickly and effectively, especially for components that have an angular alignment land 260. The present invention may also be employed in aligning and welding smaller diameter components 12, 14. The relatively large axial alignment forces that may be generated by the welding alignment device 10 may be used to assist in aligning components that exhibit characteristics such as being out of round. This is particularly true for components that employ the angular alignment land 260 feature, as the relatively large force F applied to components 12, 14 having such an angular alignment land 260 tend to generate relatively large self-aligning forces as the beveled surfaces that define the angular alignment land 260 are urged together. However, it should be understood that the present invention is not limited to aligning and/or welding components having such an angular alignment land 260.

Once the weld joint is properly aligned, both axially and circumferentially, the joint may be welded using a variety of known techniques, such as, for example, submerged arc welding (SAW), gas metal arc welding (GMAW) or SAW in combination with GMAW techniques. The joint may be welded using the practices and procedures described in API's specification entitled “Welding Connectors to Pipe” (API Recommended Practice 5C6, First Edition, December 1996), which is hereby incorporated by reference in its entirety. The welding torch 68 can be properly located using the positioning mechanisms described above.

In the embodiment disclosed herein, the device 10 includes several systems that are actuated manually, e.g., the threaded jack 70, the ratchet wrench 62, the positioning of the end rollers 34, etc. However, it should be understood that, if desired, those features or functions could be performed by automated electromechanical systems having a vast variety of different configurations.

In further embodiments of the present invention, the alignment device 10 may be positioned on a skid that may be readily transported to various locations within a facility by use of a crane, or transported to various locations by truck. In addition to the cradle assembly 42, such a skid unit may include one or more sets of manipulatable pipe rollers on the skid to support the distal end of the second component 14. Such a pipe roller may be positioned on top of wear pads (Turcite) which are in contact with wear plates welded to the base or skid. The pipe roller assembly may be free-floating on the wear pads, but it may be rotated or twisted (in a plane parallel to the surface of the skid) by two motor driven ball screw units, each of which is pinned to one side of the pipe roller assembly. The ball screw units may be employed to properly orient and position the distal end of the second component 14.

The present invention is generally directed to a welding alignment device for positioning a first component and a second component together such that the components may be welded together. In one illustrative embodiment, the device comprises a moveable body, a cradle assembly coupled to the body, the cradle assembly adapted to have at least the first component positioned therein, and a motor that, when actuated, causes an alignment force to be applied to the first component that urges the first component into contact with the second component.

In another illustrative embodiment, the welding alignment device for positioning a first component and a second component together such that the components may be welded together comprises a moveable body, a cradle assembly coupled to the body, the cradle assembly comprising a plurality of rollers that are adapted to engage an exterior surface of at least the first component when the first component is positioned in the cradle assembly, an electric motor, a gear reduction drive that is operatively coupled to the electric motor, a pinion that is operatively coupled to the gear reduction drive, and a rack that is fixedly coupled to a base frame, the rack being operatively engaged with the pinion, whereby the motor, when actuated, causes an alignment force to be applied to the first component that urges the first component into contact with the second component.

In yet another illustrative embodiment, the welding alignment device for positioning a first component and a second component together such that the components may be welded together comprises a moveable body, means for supporting at least the first component when the first component is positioned therein, the means for supporting the first component being coupled to the body, and means for generating an alignment force to be applied to the first component that urges the first component into contact with the second component, at least a portion of the means being coupled to the moveable body.

In one embodiment, the means for supporting at least the first component comprises at least the roller 46 of the cradle assembly 42. In further embodiments, the means for supporting the first component additionally comprises the guide posts 50, the guide structures 52 and the ratchet wrench 62.

In one embodiment, the means for generating an alignment force comprises the motor 54. In further embodiments, the means for generating the alignment force additionally comprises the rack 58 and the pinion 60. In even further embodiments, the means for generating the axial force additionally comprises the gear reduction drive 56.

In one embodiment, the means for axially positioning the welding torch 68 comprises the axial rack 82 and the pinion 84. In one embodiment, the means for vertically positioning the welding torch 68 comprises the vertical rack 90 and its associated pinion.

The particular embodiments disclosed above are illustrative only, as the invention may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A welding alignment device for positioning a first component and a second component together such that the components may be welded together, comprising:
a moveable body;
a cradle assembly coupled to said body, said cradle assembly adapted to have said first component positioned therein; and
a motor that, when actuated, causes an alignment force to be applied to said first component that urges said first component into contact with said second component.

2. The device of claim 1, wherein said first component is a threaded connector and said second component is a length of pipe.

3. The device of claim 1, wherein said cradle assembly comprises a plurality of rollers that are adapted to engage an exterior surface of at least said first component when said first component is positioned in said cradle.

4. The device of claim 1, wherein said cradle assembly is vertically positionable.

5. The device of claim 1, wherein said cradle assembly is comprised of a plurality of guide posts, each of which are positioned in a guide structure that is fixedly coupled to said moveable body.

6. The device of claim 1, wherein said cradle assembly is comprised of a threaded post and a ratchet wrench that enables vertical positioning of said cradle assembly.

7. The device of claim 1, further comprising at least one end roller that is coupled to said moveable body, said at least one end roller adapted to engage an end surface of said first component when said first component is positioned in said cradle.

8. The deice of claim 7, wherein said at least one end roller is removably coupled to at least one post that is fixedly coupled to said moveable body.

9. The device of claim 1, further comprising a plurality of end rollers that are coupled to said moveable body, each of said plurality of end rollers being adapted to engage an end surface of said first component when said first component is positioned in said cradle assembly.

10. The device of claim 1, further comprising:
a gear reduction drive that is operatively coupled to said motor;
a pinion that is operatively coupled to said gear reduction drive; and
a rack that is fixedly coupled to a base frame, said rack being operatively engaged with said pinion.

11. The device of claim 1, wherein said moveable body has a plurality of rollers that allow said moveable body to move relative to a base frame.

12. The device of claim 1, further comprising a welding torch that is operatively positionable so as to accomplish welding said first and second components together.

13. The device of claim 12, further comprising an axial rack and pinion that enables axial positioning of said welding torch.

14. The device of claim 12, further comprising a vertical rack and pinion that enables vertical positioning of said welding torch.

15. The device of claim 12, further comprising a milling table that enables lateral positioning of said welding torch.

16. The device of claim 1, wherein said motor is an electric motor.

17. A welding alignment device for positioning a first component and a second component together such that the components may be welded together, comprising:
a moveable body;
a cradle assembly coupled to said body, said cradle assembly comprising a plurality of rollers that are adapted to engage an exterior surface of at least said first component when said first component is positioned in said cradle;
an electric motor;
a gear reduction drive that is operatively coupled to said electric motor;
a pinion that is operatively coupled to said gear reduction drive; and
a rack that is fixedly coupled to a base frame, said rack being operatively engaged with said pinion, whereby the motor, when actuated, causes an alignment force to be applied to said first component that urges said first component into contact with said second component.

18. The device of claim 1 7, wherein said first component is a threaded connector and said second component is a length of pipe.

19. The device of claim 1 7, wherein said cradle assembly is vertically positionable.

20. The device of claim 1 7, wherein said cradle assembly is comprised of a plurality of guide posts, each of which are positioned in a guide structure that is fixedly coupled to said moveable body.

21. The device of claim 1 7, wherein said cradle assembly is comprised of a threaded post and a ratchet wrench that enables vertical positioning of said cradle assembly.

22. The device of claim 1 7, further comprising at least one end roller that is coupled to said moveable body, said at least one end roller adapted to engage an end surface of said first component when said first component is positioned in said cradle.

23. The deice of claim 22, wherein said at least one end roller is removably coupled to at least one post that is fixedly coupled to said moveable body.

24. The device of claim 1 7, further comprising a plurality of end rollers that are coupled to said moveable body, each of said plurality of end rollers being adapted to engage an end surface of said first component when said first component is positioned in said cradle assembly.

25. The device of claim 17, wherein said moveable body has a plurality of rollers that allow said moveable body to move relative to a base frame.

26. The device of claim 1 7, further comprising a welding torch that is positionable so as to accomplish welding said first and second components together.

27. The device of claim 26, further comprising an axial rack and pinion that enables axial positioning of said welding torch.

28. The device of claim 26, further comprising a vertical rack and pinion that enables vertical positioning of said welding torch.

29. The device of claim 26, further comprising a milling table that enables lateral positioning of said welding torch.

30. A welding alignment device for positioning a first component and a second component together such that the components may be welded together, comprising:
a moveable body;
means for supporting at least said first component when said first component is positioned therein, said means for supporting said first component being coupled to said body; and
means for generating an alignment force to be applied to said first component that urges said first component into contact with said second component, at least a portion of said means being coupled to said moveable body.

31. The device of claim 30, wherein said first component is a threaded connector and said second component is a length of pipe.

32. The device of claim 30, wherein said means for supporting said first component comprises at least a plurality of rollers that are adapted to engage an exterior surface of at least said first component when said first component is positioned in said means for supporting said first component.

33. The device of claim 30, wherein said means for supporting at least said first component is vertically positionable.

34. The device of claim 30, wherein said means for supporting at least said first component is comprised of a plurality of guide posts, each of which are positioned in a guide structure that is fixedly coupled to said moveable body.

35. The device of claim 30, wherein said means for supporting said first component comprises at least a threaded post and a ratchet wrench that enables vertical positioning of said means for supporting at least said first component.

36. The device of claim 30, wherein said means for generating an alignment force comprises an electric motor.

37. The device of claim 30, wherein said means for generating an alignment force comprises:
an electric motor;
a gear reduction drive that is operatively coupled to said motor;
a pinion that is operatively coupled to said gear reduction drive; and
a rack that is fixedly coupled to a base frame, said rack being operatively engaged with said pinion.

38. The device of claim 30, wherein said moveable body has a plurality of rollers that allow said moveable body to move relative to a base frame.

39. The device of claim 30, further comprising at least one end roller that is operatively coupled to said moveable body, said at least one end roller adapted to engage an end surface of said first component when said first component is positioned in said means for supporting at least said first component.

40. The deice of claim 39, wherein said at least one end roller is removably coupled to at least one post that is fixedly coupled to said moveable body.

41. The device of claim 30, further comprising a plurality of end rollers that are coupled to said moveable body, each of said plurality of end rollers being adapted to engage an end surface of said first component when said first component is positioned in said means for supporting at least said first component.

42. The device of claim 30, further comprising a welding torch that is positionable so as to accomplish welding said first and second components together.

43. The device of claim 42, further comprising means for axially positioning said welding torch.

44. The device of claim 42, wherein said means for axially positioning said welding torch comprises a rack and a pinion

45. The device of claim 42, further comprising means for vertically positioning said welding torch.

46. The device of claim 45, wherein said means for vertically positioning said welding torch comprises a rack and a pinion.

47. The device of claim 42, further comprising means for laterally positioning said welding torch.

48. The device of claim 47, wherein said means for laterally positioning said welding torch comprises a milling table.
